(19) United States
(12) Patent Application Publication
(10) Pub. No.: US 2026/0350376 A1
(43) Pub. Date: Nov. 5, 2026

(54) MODEL COMPRESSION METHOD AND APPARATUS BASED ON MODEL PROFILING

(71) Applicants: HYUNDAI MOTOR COMPANY, Seoul (KR); Kia Corporation, Seoul (KR)

(72) Inventors: Keonho LEE, Hwaseong-si (KR); Yujin LEE, Hwaseong-si (KR); Moonsub JIN, Hwaseong-si (KR); Jingang HUH, Hwaseong-si (KR)

(21) Appl. No.: 19/429,297

(22) Filed: Dec. 22, 2025

(30) Foreign Application Priority Data
May 2, 2025 (KR) 10-2025-0058010

(51) Int. Cl. G06N 3/0495

(52) U.S. Cl. CPC G06N 3/0495

(57) ABSTRACT

A model profiling-based model compression method includes receiving information regarding a target model and information regarding a target device, profiling the target model on the target device to determine a latency value for each layer of the target model, generating, by the processor, a latency database that associates each layer with a corresponding latency value, selecting, by the processor, one or more layers for compression based on a ranking of the layers according to latency values of the layers, calculating, by the processor, a compression priority level for each selected layer based on the latency values of the selected one or more layers, and performing, by the processor, compression on the selected one or more layers using a compression technique selected according to the compression priority level of each of the selected one or more layers.

### CROSS-REFERENCE TO RELATED APPLICATION

This application claims priority to and the benefit of Korean Patent Application No. 10-2025-0058010 filed with the Korean Intellectual Property Office on May 2, 2025, the entire contents of which are incorporated herein by reference.

### TECHNICAL FIELD

The disclosure relates to a model compression method and apparatus based on model profiling.

### BACKGROUND

With the advancement of deep learning technologies, artificial intelligence models are increasingly applied across diverse domains, and high-performance, large-scale neural networks are continuously being developed. However, these large-scale models can demand substantial computational power and memory, which can restrict their deployment in scenarios requiring real-time responses or operating under limited computational resources. In particular, lightweight models play critical role in environments such as mobile devices, Internet of Things (IoT) systems, and edge computing platforms. To help address such challenges, research or model compression techniques has intensified, aiming to reduce model size and complexity by removing redundant parameters and optimizing computational structures. Representative approaches include pruning, quantization, and knowledge distillation.

### SUMMARY

The present disclosure is directed to a model compression method and apparatus based on model profiling, capable of reducing a depth and width of a model to effectively reduce a model inference velocity in an environment with limited computing resources such as an edge device.

According to one aspect of the present disclosure, a model profiling-based model compression method performed by a computing device including a processor and a memory can include receiving, by the processor, information regarding a target model and information regarding a target device, profiling, by the processor, the target model on the target device to determine a latency value for each layer of the target model, generating, by the processor, a latency database that associates each layer with a corresponding latency value, selecting, by the processor, one or more layers for compression based on a ranking of the layers according to latency values of the layers, calculating, by the processor, a compression priority level for each selected layer based on the latency values of the selected one or more layers, and performing, by the processor, compression on the selected one or more layers using a compression technique selected according to the compression priority level of each of the selected one or more layers.

In some implementations, the method can further include performing, by the processor, layer calibration for the selected one or more layers. In some examples, performing the layer calibration can include updating, by the processor, batch normalization parameters by recalculating an average and a variance for the corresponding layer.

In some implementations, calculating of the compression priority level can include calculating, by the processor, the compression priority level according to following Equation 1:

$$Layer Compression Importance = performance ( {f}_{w} ) - performance ( {f}_{\tilde{w}} ) \qquad ( Equation 1 )$$

wherein performance (f_{w}) indicates performance of a pretrained model, and performance (f_{\tilde{w}}) indicates performance of the merged model.

In some implementations, performing the compression can includes performing, by the processor, layer merging on the selected layer based on the compression priority level exceeding a predetermined threshold, and performing, by the processor, pruning on the selected layer based on the compression priority level being less than or equal to the threshold value. In some implementations, the method can further include determining, by the processor, whether a compression ratio of the target model on which the compression is performed has reached a predetermined target compression ratio, and selecting, by the processor, one or more layers from the latency database based on the compression ratio being less than the target compression ratio.

In some examples, the method can further include performing, by the processor, fine-tuning based on a reconstruction error on the target model based on the compression ratio being equal to or greater than the target compression ratio. In some example, performing the fine-tuning based on the reconstruction error can include performing, by the processor, the fine-tuning based on a loss defined by following Equation 2:

$$Total Loss = {\sum }_{l = 0}^{L} ‖ {Y}^{l} - {\hat{Y}}^{l} ‖ + KL Divergence ( {T}_{logits} , {C}_{logits} ) \qquad ( Equation 2 )$$

Herein, T represents a pretrained model, C represents a compressed model based on T, L represents a number of layers in the model, Y^{l} represents a feature map output from a l^{th} layer of the pretrained model, and Ŷ^{l} represents the feature map output from the l^{th} layer of the compressed model, and KL Divergence( ) may be defined according to Equation 3 below:

$$KL Divergence ( P , Q ) = {\sum }_{x} P ( X ) * log \frac{P ( X )}{Q ( X )} \qquad ( Equation 3 )$$

wherein P represents true distribution, Q represents approximated distribution.

In some implementations, the method can further include performing, by the processor, the compression, and then performing the fine-tuning based on the reconstruction error on the target model. In some implementations, the method can further include performing, by the processor, fine-tuning based on a loss defined according to Equation 4 below, based on the compression ratio being equal to or greater than the target compression ratio:

$$Loss = KL Divergence ( {T}_{logits} , {C}_{logits} ) \qquad ( Equation 4 )$$

Herein, T represents a pretrained model, C represents a compressed model based on T, and KL Divergence( ) may be defined according to following Equation 5:

$$KL Divergence ( P , Q ) = {\sum }_{x} P ( X ) * log \frac{P ( X )}{Q ( X )} \qquad ( Equation 5 )$$

wherein P represents true distribution, Q represents approximated distribution. In some examples, the target device can include at least one of a central processing unit (CPU) or a graphics processing unit (GPU).

According to another aspect of the present disclosure, a model profiling-based model compression method performed by a computing device including a processor and a memory can include converting, by the processor, a target model for a target device into an intermediate representation (IR) graph, profiling, by the processor, the target model on the target device to determine a latency value for each layer of the target model converted into the IR graph, generating, by the processor, a latency database that associates each layer with a corresponding latency value, selecting, by the processor, one or more layers for compression based on a raking of the layers according to latency values of the layers, calculating, by the processor, a compression priority level for each selected layer based on the latency values of the selected one or more layers, and performing, by the processor, compression on the selected one or more layers using a compression technique selected according to the compression priority level of each of the selected one or more layers.

In some implementations, determining the latency for each layer can includes measuring, by the processor, an inference time for each layer of the target model converted into the IR graph, and determining, by the processor, the inference time as a delay time for each layer. In some implementations, performing the compression can include performing, by the processor, layer merging on the selected layer based on the compression priority level exceeding a predetermined threshold, and performing, by the processor, pruning on the selected layer based on the compression priority level being less than or equal to the threshold.

In some example, the method can further include determining, by the processor, whether a compression ratio of the target model on which the compression is performed has reached a predetermined target compression ratio, and selecting, by the processor, one or more layers from the latency database based on the compression ratio being less than the target compression ratio.

According to another aspect of the present disclosure, a model compression apparatus can include one or more non-transitory computer-readable media storing instructions, and one or more processors configured to execute the instructions to perform an operation. The operation can include receiving information regarding a target model and information regarding a target device, profiling the target model on the target device to determine a latency value for each layer of the target model, generating a latency database that associates each layer with a corresponding latency value, selecting one or more layers for compression based on a ranking of the layers according to latency value of the layers, calculating a compression priority level for each selected layer based on the latency values of the selected one or more layers, and performing compression on the selected one or more layers using a compression technique selected according to the compression priority level of each of the selected one or more layers.

In some implementations, performing the compression can include performing layer merging on the selected layer based on the compression priority level exceeding a predetermined threshold, and performing pruning on the selected layer based on the compression priority level being less than or equal to the threshold. In some implementations, the operation can include determining whether a compression ratio of the target model on which the compression is performed has reached a predetermined target compression ratio, and selecting one or more layers from the latency database based on the compression ratio being less than the target compression ratio.

In some examples, the operation can include performing fine-tuning based on a reconstruction error on the target model based on the compression ratio being equal to or greater than the target compression ratio. In some examples, the operation can include performing the compression and then performing the fine-tuning based on the reconstruction error on the target model.

### BRIEF DESCRIPTION OF THE DRAWINGS

FIG. 1 illustrates a block diagram for an example of a model compression apparatus.

FIG. 2 illustrates a flowchart for an example of a model compression method.

FIG. 3 illustrates a flowchart for an example of a model compression method.

FIG. 4 illustrates a flowchart for an example of a model compression method.

FIG. 5 illustrates a flowchart for an example of a model compression method.

FIG. 6 illustrates a view for an example of a computing device.

### DETAILED DESCRIPTION

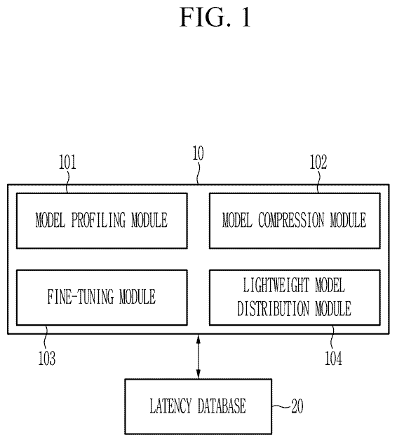

FIG. 1 illustrates a block diagram for an example of a model compression apparatus.

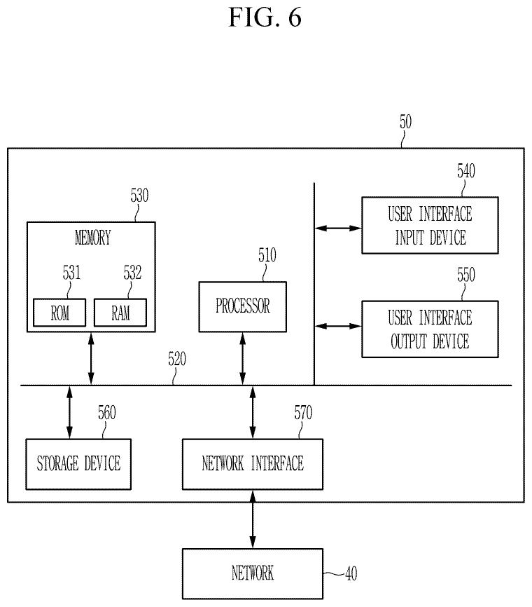

Referring to FIG. 1, the model compression apparatus 10 can be implemented as a computing device including a processor and a memory. For example, the model compression apparatus 10 can be implemented as a computing device 50 as described below with reference to FIG. 6. In this case, the processor can correspond to a processor 510 of the computing device 50, and the memory can correspond to a memory 520 of the computing device 50. In some implementations, the model compression apparatus 10 can include one or more non-transitory computer-readable media storing instructions and one or more processors for executing the instructions to perform operations. Herein, the operations can include a configuration, a function, a step, etc. described in this specification with respect to the model compression method and apparatus. In this specification, the term “module” is used to logically distinguish these operations performed by the model compression method and apparatus.

Equations expressed in this specification can be implemented in a form of calculation data and a program code. Herein, the calculation data can include parameters of a mathematical model and an input value for a calculation executed by the model compression apparatus 10 implemented as a computing device, and the program code can include a software routine for executing a corresponding equation. These can be stored on a storage device accessible to the model compression apparatus 10, or stored on a remote computing device or a cloud environment. The model compression apparatus 10 can load the calculation data and the program code directly from a storage device into a memory, or can receive the calculation data and the program code from the remote computing device or the cloud environment through a network and load them into the memory, in order to execute a calculation based on a mathematical model on a basis of corresponding equations.

The model compression apparatus 10 can include a model profiling module 101, a model compression module 102, a fine-tuning module 103, and a lightweight model distribution module 104.

The model profiling module 101 can receive information regarding a target model and information regarding a target device. Herein, the target model can be a target deep learning model for which lightweighting is to be performed, can include multiple layers, and each layer can include calculation units such as convolution calculations, activation functions, normalization, and pooling. The model profiling module 101 can receive, as information about the target model, data about structural and computational characteristics, such as a calculation type of each layer constituting the model, a number of parameters, a size of input/output tensors, a computational load (FLOPs), a memory usage, a connection structure, etc., from a storage device, a remote computing device, or a cloud environment.

In some implementations, the target device can be a final execution environment in which the target model will be deployed and operated. The target device can be an edge device, a mobile device, an Internet of Things (IoT) device, or an embedded system with limited computational resources and memory. The model profiling module 101 can receive data regarding various information about the target device, such as the type and performance of the device's computational resources, a memory capacity and bandwidth, supported computational precision, power consumption constraints of the device, parallel processing capability, operating system, and runtime environment, from the storage device, the remote computing device, or the loud environment.

The model profiling module 101 can determine layer-by-layer latency of the target model for the target device based on the received information. For example, the model profiling module 101 can profile the target model on the target device to determine a latency value for each layer of the target model. Latency for each layer can be a time it takes for each layer that makes up the target model to run on the target device. The latency for each layer can be determined based on, e.g., computational complexity of the layer, a parameter size, a size and format of input/output data, and a computational resource characteristic of the target device. Such latency can be measured while each layer's computation is performed on hardware components such as the target device's central processing unit (CPU), graphics processing unit (GPU), and neural processing unit (NPU), or can be predicted based on previously collected measurement data.

In some implementations, the model profiling module 101 can convert a target model for a target device into an intermediate representation (IR) graph to determine layer-by-layer latency, and determine the layer-by-layer latency of the target model converted into the IR graph. Herein, the IR graph can be a standardized format that converts the target model into a specific framework-independent format, and can be a graph representation of the model's computational structure formed of nodes and edges. Herein, each node can represent one computational unit, such as convolution, activation function, regularization, etc., and an edge can represent data flow between calculations. In some implementations, the IR graph can be generated in an open neural network exchange (ONNX) format.

In some implementations, the model profiling module 101 can measure an inference time for each layer of the target model converted into an IR graph, and determine the measured inference time as the layer-by-layer latency. For example, in order to measure the inference time for each layer of the target model converted into the IR graph, the model profiling module 101 can execute individual calculations for each node of the IR graph on the target device, and measure a time required for the calculation until it is completed. In this case, an actual inference time for each node can be calculated based on start and end points of the calculation of each node. For example, the model profiling module 101 can perform individual executions on computational nodes on an IR graph by utilizing a runtime environment such as ONNX runtime to collect a profiling result for each node.

The model profiling module 101 can create a latency database including the layer-by-layer latency collected in this manner. For example, the model profiling module 101 can generate a latency database that associates each layer with a corresponding latency value. The latency database can be a structured storage of measured latency information when each layer of the target model is executed on the target device, and can be automatically generated or updated by the model profiling module 101. In some implementations, the latency database can be implemented in a form of a table that includes information such as a unique identifier of each layer, a layer type, shapes of input and output tensors, computational precision, an execution environment, a measured average inference time and standard deviation, etc.

The model compression module 102 can determine one or more target layers selected in order of increasing latency in the latency database. For example, the model compression module 102 can select one or more layers for compression based on a ranking of the layers according to latency values of the layers. Additionally, the model compression module 102 can calculate layer compression importance for each target layer. Specifically, the model compression module 102 can select one or more target layers in order of decreasing latency based on information obtained in the latency database. For example, starting from a top-1 layer with a largest latency, determination can be made on whether to remove the layer itself or eliminate channels within the layer, and this determination can be based on the layer compression importance calculated for each target layer.

The layer compression importance can be an indicator that quantitatively evaluates an impact on model performance when merging specific layers or applying pruning within a layer, and can be used to preferentially apply compression to computational units with less performance degradation. In this case, if an activation function between layers is changed to identity mapping for layer merging, distribution of an input passed to a next layer may change, causing input mean/variance shift. A change in such an input statistic may lead to a decline in model performance, and, accordingly, the model compression module 102 can apply layer calibration to compensate for this effect.

In some implementations, the model compression module 102 can perform the layer calibration only for the target layer, and update average and dispersion of batch normalization to perform the layer calibration. For example, the model compression module 102 can update batch normalization parameters by recalculating an average and a variance for the corresponding layer.

In some implementations, the model compression module 102 can calculate the layer compression importance according to Equation 1 below.

Layer Compression Importance=performance(f_{w})−performance(f_{\tilde{w}}) (Equation 1)

Herein, performance (f_{w}) can indicate performance of a pretrained model, performance (f_{\tilde{w}}) can indicate performance of the merged model.

The model compression module 102 can perform compression on the target layer in different ways depending on a value of the layer compression importance. For example, model compression module 102 can perform compression on the selected one or more layers using a compression technique selected according to the compression priority level of each of the selected one or more layers. Specifically, the model compression module 102 can perform layer merging on the target layer when the value of the layer compression importance exceeds a predetermined threshold, and can perform pruning on the target layer when the value of the layer compression importance is less than or equal to the threshold. In some implementations, the model compression module 102 can determine whether a compression ratio of the target model on which compression has been performed has reached a predetermined target compression ratio, and can re-determine the target layer based on the latency database.

For example, the model compression module 102 can apply an optimized compression strategy for each layer by selectively performing either layer merging or pruning based on the layer compression importance value for the target layer. In this case, layer merging can provide an effect of reducing a computational load by simplifying a structure between computational units, and pruning can simultaneously reduce a memory usage and the computational load by reducing a number of channels within a layer.

While this compression process is repeatedly performed, the model compression module 102 can continuously evaluate a cumulative compression ratio of the model to which compression has been applied so far, and can determine whether the compression ratio has reached the predetermined target compression ratio, thereby determining whether the compression process is terminated. If the cumulative compression ratio does not reach the target compression ratio, the model compression module 102 can newly select the next target layer by referring to the latency database again and repeat layer merging or pruning in a same manner as that of the previous process. Through this iterative process, the model compression module 102 can optimize a structure of the model in an incremental and quantitative manner until the target compression ratio is finally reached.

The fine-tuning module 103 can perform fine-tuning based on a reconstruction error for the target model when it is determined that the compression ratio has reached the target compression ratio.

In some implementations, the fine-tuning module 103 can perform fine-tuning based on a loss defined according to following Equation 2.

$$Total Loss = {\sum }_{l = 0}^{L} ‖ {Y}^{l} - {\hat{Y}}^{l} ‖ + KL Divergence ( {T}_{logits} , {C}_{logits} ) \qquad ( Equation 2 )$$

Herein, T represents a pretrained model, C represents a compressed model based on T, L represents a number of layers in the model, Y^{l} represents a feature map output from a l^{th} layer of the pretrained model, and Ŷ^{l} represents the feature map output from the l^{th} layer of the compressed model, and KL Divergence( ) can be defined according to Equation 3 below.

$$KL Divergence ( P , Q ) = {\sum }_{x} P ( X ) * log \frac{P ( X )}{Q ( X )} \qquad ( Equation 3 )$$

Herein, P can represent a true distribution, and Q can represent an approximated distribution.

The lightweight model deployment module 104 can distribute a lightweight model selected through the above process to a final execution environment, i.e., the target device.

In some implementations, by utilizing a convolution filter coupling principle within a layer, layer merging and layer channel pruning can be performed, enabling a model compression technique applicable to various models with block-based convolutional structures. In addition, by applying a model lightweight technology optimized for the environment of the target device, a computational resource and a memory usage can be reduced compared to an original model. Furthermore, a resource saving effect secured through the model compression technique can serve as a basis for loading more deep learning models in a same system or providing a high-quality artificial intelligence service.

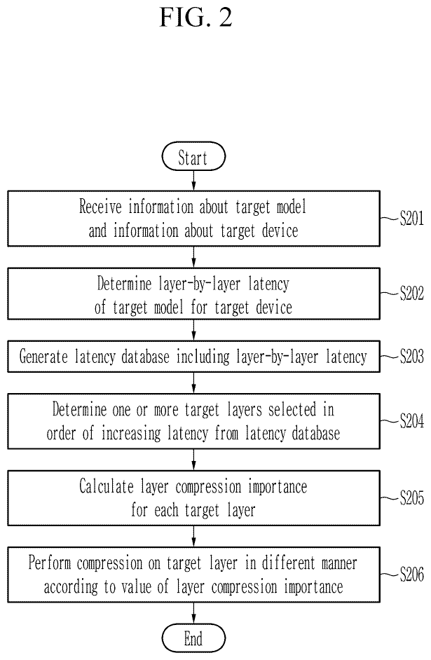

FIG. 2 illustrates a flowchart for an example of a model compression method.

Referring to FIG. 2, a model compression method can include an operation of receiving information regarding a target model and information regarding a target device (S201), an operation of determining a layer-by-layer latency of the target model for the target device (S202), an operation of generating a latency database including a layer-by-layer latency (S203), an operation of determining one or more target layers selected in order of increasing latency from the latency database (S204), an operation of calculating layer compression importance for each target layer (S205), and an operation of performing compression on the target layer in a different manner according to a value of the layer compression importance (S206).

For more detailed information on the method, reference may be made to contents of other implementations described in this specification, so a redundant content will be omitted herein.

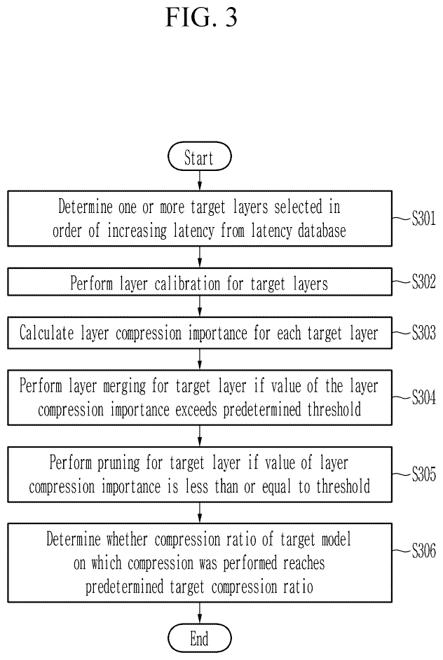

FIG. 3 illustrates a flowchart for an example of a model compression method.

Referring to FIG. 3, a model compression method can include an operation of determining one or more target layers selected in order of increasing latency from a latency database (S301), an operation of performing layer calibration for the target layers (S302), an operation of calculating layer compression importance for each target layer (S303), an operation of performing layer merging for the target layer if a value of the layer compression importance exceeds a predetermined threshold (S304), an operation of performing pruning for the target layer if the value of the layer compression importance is less than or equal to the threshold (S305), and an operation of determining whether a compression ratio of a target model on which compression was performed reaches a predetermined target compression ratio (S306).

For more detailed information on the method, reference may be made to contents of other implementations described in this specification, so a redundant content will be omitted herein.

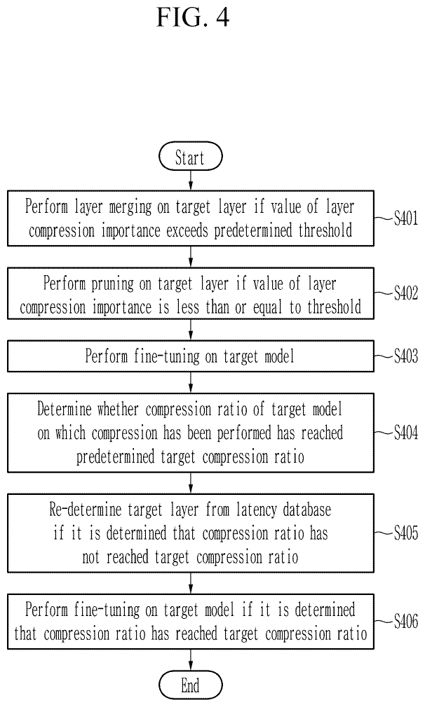

FIG. 4 illustrates a flowchart for an example of a model compression method.

Referring to FIG. 4, a model compression method can include an operation of performing layer merging on a target layer if a value of layer compression importance exceeds a predetermined threshold (S401), an operation of performing pruning on the target layer if the value of the layer compression importance is less than or equal to the threshold (S402), an operation of performing fine-tuning on a target model (S403), an operation of determining whether a compression ratio of the target model on which compression has been performed has reached a predetermined target compression ratio (S404), an operation of re-determining the target layer from a latency database if it is determined that the compression ratio has not reached the target compression ratio (S405), and an operation of performing fine-tuning on the target model if it is determined that the compression ratio has reached the target compression ratio (S406).

For more detailed information on the method, reference may be made to contents of other implementations described in this specification, so a redundant content will be omitted herein.

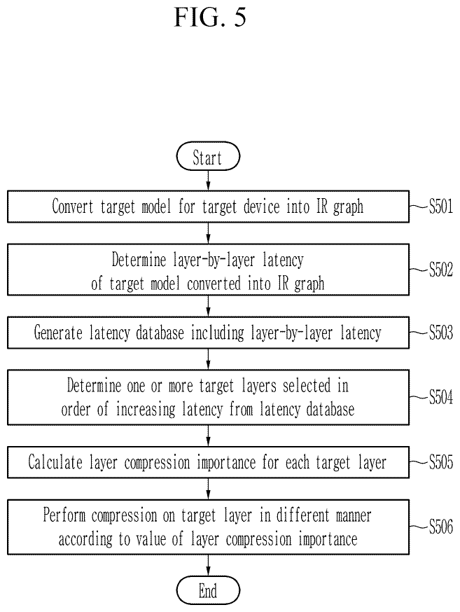

FIG. 5 illustrates a flowchart for an example of a model compression method.

Referring to FIG. 5, a model compression method can include an operation of converting a target model for a target device into an IR graph (S501), an operation of determining a layer-by-layer latency of the target model converted into the IR graph (S502), an operation of generating a latency database including a layer-by-layer latency (S503), an operation of determining one or more target layers selected in order of increasing latency from the latency database (S504), an operation of calculating layer compression importance for each target layer (S505), and an operation of performing compression on the target layer in a different manner according to a value of the layer compression importance (S506).

For more detailed information on the method, reference may be made to contents of other implementations described in this specification, so a redundant content will be omitted herein.

FIG. 6 illustrates a view for an example of a computing device.

Referring to FIG. 6, a model compression method and apparatus based on model profiling can be implemented using the computing device 50. The computing device 50 can be implemented as various forms of electronic devices, servers, or similar devices, and their functions can be implemented through a combination of software and hardware.

The computing device 50 can include at least one of a processor 510, a memory 530, a user interface input device 540, a user interface output device 550, and a storage device 560 which communicate each other via a bus 520. The computing device 50 can also include a network interface 570 electrically connected to a network 40. The network interface 570 can transmit or receive signals to or from other elements through the network 40.

The processor 510 can be implemented as various types of computational devices, such as a micro controller unit (MCU), an application processor (AP), a central processing unit (CPU), a graphic processing unit (GPU), a neural processing unit (NPU), a quantum processing unit (QPU), etc. The processor 510 can be a semiconductor device that executes instructions stored in a memory 530 or a storage device 560, and can play a key role in the system. Program codes and data stored in the memory 530 or the storage device 560 can instruct the processor 510 to perform specific tasks, thereby enabling a general operation of the system. The processor 510 can be configured to implement various functions and methods described above with respect to FIGS. 1 to 6.

The memory 530 and the storage device 560 can include various forms of volatile or non-volatile storage media for storing and accessing data of the system. For example, the memory 530 can include a read only memory (ROM) 531 and a random access memory (RAM) 532. In some implementations, the memory 530 can be embedded within the processor 510, in which case a data transmission speed between the memory 530 and the processor 510 may be very fast. In some implementations, the memory 530 can be positioned external to the processor 510, in which case the memory 530 can be connected to the processor 510 via various data buses or interfaces. This connection can be made through a variety of already known means, e.g., a peripheral component interconnect express (PCIe) interface for high-speed data transfer or through a memory controller.

In some implementations, at least some of the components or functions of the model compression method and apparatus based on model profiling can be implemented as a program or software running on the computing device 50, and the program or software can be stored on a computer-readable recording medium or storage medium. Specifically, a computer-readable recording medium or storage medium can be a program recorded on a computer including the processor 510 that executes a program or command stored in the memory 530 or the storage device 560 to execute operations included in the implementation of the model compression method and apparatus based on model profiling.

In some implementations, at least some of the components or functions of the model compression method and apparatus based on model profiling can be implemented using hardware or circuitry of the computing device 50, or can be implemented as separate hardware or circuitry that can be electrically connected to the computing device 50.

In some implementations, the computing device 50 can be provided with one or more non-transitory computer-readable media containing executable instructions, which, when executed by one or more processors of the computing device 50, cause the computing device 50 to perform operations. Herein, the operations can include a configuration, a function, a step, etc. described in this specification with respect to the model compression method and apparatus based on model profiling.

According to the implementations, by utilizing a convolution filter coupling principle within a layer, layer merging and layer channel pruning may be performed, enabling a model compression technique applicable to various models with block-based convolutional structures. In addition, by applying a model lightweight technology optimized for the environment of the target device, a computational resource and a memory usage can be reduced compared to an original model. Furthermore, a resource saving effect secured through the model compression technique can serve as a basis for loading more deep learning models in a same system or providing a high-quality artificial intelligence service.

What is claimed is:

1. A model profiling-based model compression method performed by a computing device including a processor and a memory, the method comprising:
receiving, by the processor, information regarding a target model and information regarding a target device;
profiling, by the processor, the target model on the target device to determine a latency value for each layer of the target model;
generating, by the processor, a latency database that associates each layer with a corresponding latency value;
selecting, by the processor, one or more layers for compression based on a ranking of the layers according to latency values of the layers;
calculating, by the processor, a compression priority level for each selected layer based on the latency values of the selected one or more layers; and
performing, by the processor, compression on the selected one or more layers using a compression technique selected according to the compression priority level of each of the selected one or more layers.

2. The model compression method of claim 1, further comprising
performing, by the processor, layer calibration for the selected one or more layers.

3. The model compression method of claim 2, wherein performing the layer calibration includes updating, by the processor, batch normalization parameters by recalculating an average and a variance for the corresponding layer.

4. The model compression method of claim 1, wherein calculating of the compression priority level includes calculating, by the processor, the compression priority level according to following Equation 1:
$$Layer Compression Importance = performance ( {f}_{w} ) - performance ( {f}_{\tilde{w}} ) \qquad ( Equation 1 )$$
wherein performance (f_{w}) indicates performance of a pretrained model, and performance (f_{\tilde{w}}) indicates performance of a merged model.

5. The model compression method of claim 1, wherein performing the compression includes:
performing, by the processor, layer merging on the selected layer based on the compression priority level exceeding a predetermined threshold, and
performing, by the processor, pruning on the selected layer based on the compression priority level being less than or equal to the threshold value.

6. The model compression method of claim 1, further comprising:
determining, by the processor, whether a compression ratio of the target model on which the compression is performed has reached a predetermined target compression ratio, and
selecting, by the processor, one or more layers from the latency database based on the compression ratio being less than the target compression ratio.

7. The model compression method of claim 6, further comprising:
performing, by the processor, fine-tuning based on a reconstruction error on the target model based on the compression ratio being equal to or greater than the target compression ratio.

8. The model compression method of claim 7, wherein performing the fine-tuning based on the reconstruction error includes performing, by the processor, the fine-tuning based on a loss defined by following Equation 2:
$$Total Loss = {\sum }_{l = 0}^{L} ‖ {Y}^{l} - {\hat{Y}}^{l} ‖ + KL Divergence ( {T}_{logits} , {C}_{logits} ) \qquad ( Equation 2 )$$
wherein, T represents a pretrained model, C represents a compressed model based on T, L represents a number of layers in the model, Y^{l} represents a feature map output from a l^{th} layer of the pretrained model, and Ŷ^{l} represents the feature map output from the l^{th} layer of the compressed model, and KL Divergence( ) is defined according to Equation 3:
$$KL Divergence ( P , Q ) = {\sum }_{x} P ( X ) * log \frac{P ( X )}{Q ( X )} \qquad ( Equation 3 )$$
wherein P represents true distribution, and Q represents approximated distribution.

9. The model compression method of claim 7, further comprising
performing, by the processor, the compression, and then performing the fine-tuning based on the reconstruction error on the target model.

10. The model compression method of claim 7, further comprising:
performing, by the processor, fine-tuning based on a loss defined according to Equation 4 below, based on the compression ratio being equal to or greater than the target compression ratio:
$$Loss = KL Divergence ( {T}_{logits} , {C}_{logits} ) \qquad ( Equation 4 )$$
wherein T represents a pretrained model, C represents a compressed model based on T, and KL Divergence( ) is defined according to following Equation 5:
$$KL Divergence ( P , Q ) = {\sum }_{x} P ( X ) * log \frac{P ( X )}{Q ( X )} \qquad ( Equation 5 )$$
wherein P represents true distribution, and Q represents approximated distribution.

11. The model compression method of claim 1, wherein
the target device includes at least one of a central processing unit (CPU) or a graphics processing unit (GPU).

12. A model profiling-based model compression method performed by a computing device including a processor and a memory, the method comprising:
converting, by the processor, a target model for a target device into an intermediate representation (IR) graph;
profiling, by the processor, the target model on the target device to determine a latency value for each layer of the target model converted into the IR graph;
generating, by the processor, a latency database that associates each layer with a corresponding latency value;
selecting, by the processor, one or more layers for compression based on a raking of the layers according to latency values of the layers;
calculating, by the processor, a compression priority level for each selected layer based on the latency values of the selected one or more layers; and
performing, by the processor, compression on the selected one or more layers using a compression technique selected according to the compression priority level of each of the selected one or more layers.

13. The model compression method of claim 12, wherein determining the latency for each layer includes:
measuring, by the processor, an inference time for each layer of the target model converted into the IR graph, and
determining, by the processor, the inference time as a delay time for each layer.

14. The model compression method of claim 12, wherein performing the compression includes:
performing, by the processor, layer merging on the selected layer based on the compression priority level exceeding a predetermined threshold; and
performing, by the processor, pruning on the selected layer based on the compression priority level being less than or equal to the threshold.

15. The model compression method of claim 12, further comprising:
determining, by the processor, whether a compression ratio of the target model on which the compression is performed has reached a predetermined target compression ratio; and
selecting, by the processor, one or more layers from the latency database based on the compression ratio being less than the target compression ratio.

16. A model compression apparatus comprising:
one or more non-transitory computer-readable media storing instructions; and
one or more processors configured to execute the instructions to perform an operation, wherein the operation includes:
receiving information regarding a target model and information regarding a target device,
profiling the target model on the target device to determine a latency value for each layer of the target model,
generating a latency database that associates each layer with a corresponding latency value,
selecting one or more layers for compression based on a ranking of the layers according to latency value of the layers,
calculating a compression priority level for each selected layer based on the latency values of the selected one or more layers, and
performing compression on the selected one or more layers using a compression technique selected according to the compression priority level of each of the selected one or more layers.

17. The model compression apparatus of claim 16, wherein performing the compression includes:
performing layer merging on the selected layer based on the compression priority level exceeding a predetermined threshold, and
performing pruning on the selected layer based on the compression priority level being less than or equal to the threshold.

18. The model compression apparatus of claim 16, wherein the operation includes:
determining whether a compression ratio of the target model on which the compression is performed has reached a predetermined target compression ratio; and
selecting one or more layers from the latency database based on the compression ratio being less than the target compression ratio.

19. The model compression apparatus of claim 18, wherein the operation includes:
performing fine-tuning based on a reconstruction error on the target model based on the compression ratio being equal to or greater than the target compression ratio.

20. The model compression apparatus of claim 19, wherein the operation includes:
performing the compression and then performing the fine-tuning based on the reconstruction error on the target model.
